(19) United States
(12) Patent Application Publication
(10) Pub. No.: US 2026/0348906 A1
(43) Pub. Date: Nov. 5, 2026

(54) Gas Detection Apparatus and Gas-Sensor Diagnosis Method

(71) Applicant: New Cosmos Electric Co., Ltd., Osaki-shi, Osaka (JP)

(72) Inventors: Kosuke KASHITANI, Osaka-shi (JP); Tomonori ISHINO, Osaka-shi (JP); Yo SUEHIRO, Osaka-shi (JP); Kotaro NOMI, Osaka-shi (JP)

(21) Appl. No.: 19/116,443

(22) PCT Filed: Dec. 19, 2024
(86) PCT No.: PCT/JP2024/044932

§ 371 Date: Mar. 28, 2025

(30) Foreign Application Priority Data
Dec. 27, 2023 (JP) 2023-221020
Jun. 28, 2024 (JP) 2024-105004

(51) Int. Cl. G01N 27/416

(52) U.S. Cl. CPC G01N 27/4163

(57) ABSTRACT

A gas detection apparatus 100 according to this invention includes a controller 1 performing failure diagnosis of a gas sensor 21 including a working electrode 21a and a counter electrode 21b based on outputs from the gas sensor 21 while switching between a charging state in which electric charge is stored in the gas sensor 21, and a discharging state in which the electric charge stored in the gas sensor 21 is released. The controller 1 determines whether the gas sensor 21 fails based on the output(s) acquired after discharging the gas sensor 21 and a predetermined threshold based on the output before charging the gas sensor 21.

### TECHNICAL FIELD

The invention relates to a gas detection apparatus and a gas-sensor diagnosis method, in particular to a gas detection apparatus and a gas-sensor diagnosis method for performing failure diagnosis of a gas sensor.

### BACKGROUND ART

Gas detection apparatuses for performing failure diagnosis of gas sensors are known in the art. Such an apparatus is disclosed in Japanese Patent Laid-Open Publication No. JP 2011-085455, for example.

The above Japanese Patent Laid-Open Publication No. JP 2011-085455 discloses an alarm (gas detection apparatus) including a gas sensor including a detection electrode and a counter electrode, a current/voltage conversion circuit converting a current flowing in the gas sensor into a voltage, and a self-diagnoser performing failure diagnosis of the gas sensor based on the output voltage of the current/voltage conversion circuit. In this alarm in the Japanese Patent Laid-Open Publication No. JP 2011-085455, the self-diagnoser stores and charges electric charge between the detection electrode and counter electrode of the gas sensor, discharges the charge, and then diagnoses the failure of the gas sensor based on the output voltage of the current/voltage conversion circuit. Also, the self-diagnoser diagnoses the failure of the gas sensor by comparing the output voltage of the current/voltage conversion circuit at a predetermined time point when charging and discharging of the gas sensor with a predetermined threshold.

### PRIOR ART

### Patent Document

Patent Document 1: Japanese Patent Laid-Open Publication No. JP 2011-085455

### SUMMARY OF THE INVENTION

### Problems to be Solved by the Invention

In the above Japanese Patent Laid-Open Publication No.

JP 2011-085455, the self-diagnoser diagnoses the failure of the gas sensor by comparing the output voltage of the current/voltage conversion circuit at a predetermined time point when charging and discharging of the gas sensor with a predetermined threshold. Accordingly, in a case in which the output voltage of the gas sensor when charged and discharged varies due to presence of a gas to be detected in its atmosphere, magnitude relation of the output voltage to the predetermined threshold will be changed. For this reason, since results of failure diagnosis of the gas sensor may be changed depending on conditions of the atmosphere, it is difficult to accurately perform failure diagnosis of the gas sensor.

The present invention is intended to solve the above problem, and one object of the present invention is to provide a gas detection apparatus and a gas-sensor diagnosis method capable of accurately performing failure diagnosis of a gas sensor irrespective of its atmosphere.

### Means for Solving the Problems

In order to attain the aforementioned object, a gas detection apparatus according to a first aspect of the present invention includes a controller performing failure diagnosis of a gas sensor including a working electrode and a counter electrode based on outputs from the gas sensor while switching between a charging state in which electric charge is stored in the gas sensor, and a discharging state in which the electric charge stored in the gas sensor is released, wherein the controller determines whether the gas sensor fails based on the output(s) acquired after discharging the gas sensor and a predetermined threshold based on the output before charging the gas sensor.

In the gas detection apparatus according to the first aspect of this invention, as discussed above, the controller is provided which determines whether the gas sensor fails based on the output(s) acquired after discharging the gas sensor and a predetermined threshold based on the output before charging the gas sensor. Accordingly, even in a case in which the output voltage of the gas sensor when charged and discharged varies due to presence of a gas to be detected in its atmosphere, it is possible to set the predetermined threshold by using the output before charging the gas sensor as a reference value. Consequently, in a case in which the gas sensor is charged and then discharged, since the output returns to a value before charging, it is possible to set the predetermined threshold for failure diagnosis to an appropriate value in accordance with the atmosphere. As a result, it is possible to accurately perform failure diagnosis of the gas sensor irrespective of the atmosphere.

In the gas detection apparatus according to the aforementioned first aspect, it is preferable that the controller sets the predetermined threshold to a value greater than the output before charging the gas sensor. According to this configuration, since the output is reliably prevented from exceeding the predetermined threshold in the event of failure by setting the predetermined threshold to a value greater than the output before charging the gas sensor, it is possible to accurately determine whether the gas sensor fails.

In the gas detection apparatus according to the aforementioned first aspect, it is preferable that the controller acquires, at different times, a plurality of outputs after discharging the gas sensor as the output(s) acquired after discharging the gas sensor and determines whether the gas sensor fails based on all of the plurality of outputs. According to this configuration, even in a case in which the time period until the output voltage of the gas Sensor exceeds the threshold when the gas sensor is charged and discharged varies depending on the individual gas sensor, since the plurality of outputs are acquired at different times after discharging the gas sensor and determines that the gas sensor fails if all of the plurality of outputs are not greater than the predetermined threshold, it is possible to accurately perform failure diagnosis of the gas sensor irrespective of the atmosphere even in a case in which individual gas sensors have differences.

In the configuration of the gas detection apparatus in which the controller determines whether the gas sensor fails based on all of the plurality of outputs acquired at different times, it is preferable that the controller acquires, at predetermined intervals, the plurality of outputs after discharging the gas sensor and determines whether the gas sensor is in a normal state or in a failure state based on the plurality of outputs acquired. According to this configuration, since the plurality of outputs are acquired at predetermined intervals after discharging the gas sensor, it is possible to reduce increase in processing load as compared with a case in which the outputs are continuously acquired after discharging the gas sensor. Also, even in a case in which the time period until the output of the gas sensor exceeds the threshold after discharging varies depending on the individual gas sensor, it is possible to accurately perform failure diagnosis of the gas sensor by acquiring the plurality of outputs at the predetermined intervals.

In this configuration, it is preferable that the controller acquires the plurality of outputs at the predetermined intervals longer than a time period required to charge the gas sensor and determines whether the gas sensor is in a normal state or in a failure state based on the plurality of outputs acquired. According to this configuration, since the outputs after discharging the gas sensor are acquired at time intervals sufficiently longer than the time period required to charge the gas sensor, it is possible to further reduce increase in processing load as compared with a case in which a larger number of outputs are acquired at shorter time intervals.

In the configuration of the gas detection apparatus in which the controller determines whether the gas sensor fails based on all of the plurality of outputs acquired at different times, it is preferable that the controller acquires the plurality of outputs at three or more different times and determines whether the gas sensor is in a normal state or in a failure state based on three or more outputs acquired as the plurality of outputs. According to this configuration, since the plurality of outputs are acquired at three or more different times, it is possible to determine whether the gas Sensor fails by acquiring the outputs after discharging over a relatively long time period.

In the gas detection apparatus according to the aforementioned first aspect, it is preferable that the controller performs no failure diagnosis of the gas sensor if the output(s) satisfies/satisfy a predetermined condition.

According to this configuration, since no failure diagnosis of the gas sensor is performed if the output(s) satisfies/satisfy a predetermined condition, it is possible to prevent interruption of detection of a gas to be detected due to failure diagnosis.

In the gas detection apparatus according to the aforementioned first aspect, it is preferable that the controller detects a gas to be detected based on a cumulative value of the outputs except during the failure diagnosis. According to this configuration, since values of the outputs when the gas sensor is charged and discharged during the failure diagnosis are not added to the cumulative value, it is possible to prevent incorrect detection of the gas to be detected.

A method for performing failure diagnosis of a gas sensor according to a second aspect of the present invention is a method for performing failure diagnosis of a gas sensor including a working electrode and a counter electrode based on outputs from the gas sensor while switching between a charging state in which electric charge is stored in the gas sensor, and a discharging state in which the electric charge stored in the gas sensor is released, the method including determining whether the gas sensor fails based on the output(s) acquired after discharging the gas sensor and a predetermined threshold based on the output before charging the gas sensor.

In the method for performing failure diagnosis of a gas sensor according to the second aspect of the present invention, as discussed above, it is determined whether the gas sensor fails based on the output(s) acquired after discharging the gas sensor and a predetermined threshold based on the output before charging the gas sensor. Accordingly, even in a case in which the output voltage of the gas sensor when charged and discharged varies due to presence of a gas to be detected in its atmosphere, it is possible to set the predetermined threshold by using the output before charging the gas sensor as a reference value. Consequently, in a case in which the gas sensor is charged and then discharged, since the output returns to a value before charging, it is possible to set the predetermined threshold for failure diagnosis to an appropriate value in accordance with the atmosphere. As a result, it is possible to accurately perform failure diagnosis of the gas sensor irrespective of the atmosphere.

In the method for performing failure diagnosis of a gas sensor according to the aforementioned second aspect, it is preferable that a gas detection apparatus is diagnosed by determining whether the gas sensor fails based on the output(s) acquired after discharging the gas sensor and the predetermined threshold based on the output before charging the gas sensor. Accordingly, it is possible to accurately diagnose the gas detection apparatus including the gas sensors by accurately performing failure diagnosis of the gas sensor irrespective of the atmosphere.

A method for performing failure diagnosis of a gas Sensor according to a third aspect of the present invention includes acquiring outputs from the gas sensor, which includes a working electrode and a counter electrode, before storing electric charge in the gas sensor to charge the gas sensor; determining a threshold based on the output before charging the gas sensor; acquiring the output(s) after discharging the gas sensor by releasing the electric charge stored in the gas sensor; and determining whether the gas sensor fails based on the threshold and the output(s) after discharging the gas sensor.

In the method for performing failure diagnosis of a gas sensor according to the third aspect of the present invention, as discussed above, determining whether the gas sensor fails based on the threshold determined based on the output before charging the gas sensor and the output(s) after discharging the gas sensor is provided. Accordingly, even in a case in which the output voltage of the gas sensor when charged and discharged varies due to presence of a gas to be detected in its atmosphere, it is possible to set the threshold by using the output before charging the gas sensor as a reference value. Consequently, in a case in which the gas sensor is charged and then discharged, since the output returns to a value before charging, it is possible to set the threshold for failure diagnosis to an appropriate value in accordance with the atmosphere. As a result, it is possible to provide a gas-sensor diagnosis method capable of accurately performing failure diagnosis of the gas sensor irrespective of the atmosphere.

### Effect of the Invention

According to the present invention, as discussed above, it is possible to accurately perform failure diagnosis of a gas sensor irrespective of its atmosphere.

### BRIEF DESCRIPTION OF THE DRAWINGS

FIG. 1 is a block diagram showing a configuration of a gas detection apparatus according to one embodiment.

FIG. 2 is a diagram showing an exemplary electrical circuit of a sensor of the gas detection apparatus according to the one embodiment.

FIG. 3 is a diagram showing the electrical circuit of the gas sensor according to the one embodiment before charging in diagnosis.

FIG. 4 is a diagram showing the electrical circuit of the gas sensor according to the one embodiment during charging in the diagnosis.

FIG. 5 is a diagram showing the electrical circuit of the gas sensor during discharging in the diagnosis according to the one embodiment.

FIG. 6 is a diagram showing an exemplary waveform of a detection signal in the diagnosis if the gas sensor according to the one embodiment is in a normal state.

FIG. 7 is a diagram showing exemplary waveforms of detection signals in the diagnosis in a case in which reference voltages of the gas sensor according to one embodiment are different from each other.

FIG. 8 is a diagram showing an exemplary waveform of a detection signal in the diagnosis in a case in which a detection signal slowly returns if the gas sensor according to the one embodiment is in a normal state.

FIG. 9 is a diagram showing the electrical circuit of the gas sensor according to the one embodiment if the gas sensor is in an open failure state.

FIG. 10 is a diagram showing an exemplary waveform of a detection signal in the diagnosis if the gas sensor according to the one embodiment is in the open failure state.

FIG. 11 is a diagram showing the electrical circuit of the gas sensor according to the one embodiment if the gas sensor is in a short failure state.

FIG. 12 is a diagram showing an exemplary waveform of a detection signal in the diagnosis if the gas sensor according to the one embodiment is in the short failure state.

FIG. 13 is a diagram showing exemplary variations of waveforms of detection signals in the diagnosis of the gas sensor according to the one embodiment over time.

### MODES FOR CARRYING OUT THE INVENTION

The following description will describe embodiments according to the present invention with reference to the drawings.

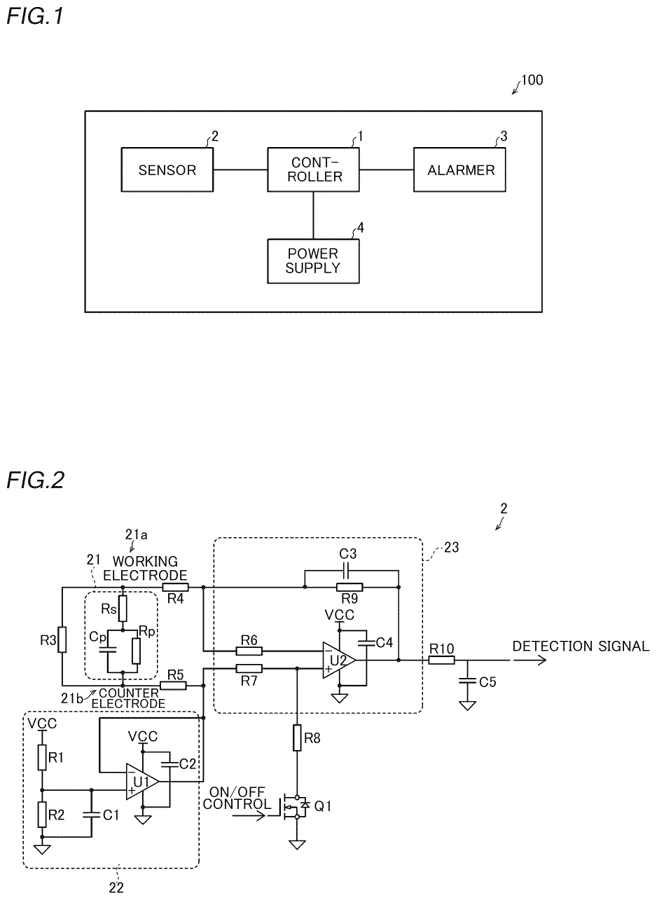

A gas detection apparatus 100 according to one embodiment is now described with reference to FIGS. 1 to 13.

### Configuration of Alarm System

As shown in FIG. 1, the gas detection apparatus 100 is configured to detect a gas to be detected and to issue an alarm.

The gas detection apparatus 100 includes a controller 1, a sensor 2, an alarmer 3, and a power supply 4, as shown in FIG. 1.

The controller 1 is configured to control parts of the gas detection apparatus 100. The controller 1 includes a processor such as an MCU (Micro Controller Unit) configured to execute a program, and a memory configured to store the program.

The sensor 2 is configured to detect the to-be-detected gas. The sensor 2 detects, for example, a CO gas, a methane gas and a propane gas as the to-be-detected gas. The sensor 2 includes an electrochemical gas sensor. The sensor 2 detects the gas based on change of an output voltage when the to-be-detected gas is present.

The alarmer 3 is configured to issue an alarm to the surrounding area if the to-be-detected gas is detected by the sensor 2. The alarmer 3 issues an alarm through buzzer sound, voice message, light output, display of information, and the like, for example. The alarmer 3 includes a speaker, a light emitter, a display screen, and the like, for example.

The power supply unit 4 supplies power to the parts of the gas detection apparatus 100. The power supply 4 includes a power conversion circuit connected to a commercial power supply. Also, the power supply 4 may be a battery, for example.

The sensor 2 includes a gas sensor 21, a constant voltage circuit 22, and a signal output 23, as shown in FIG. 2. The gas sensor 21 includes a working electrode 21a and a counter electrode 21b.

The gas sensor 21 can be represented by a circuit including a resistive component Rs, a capacitive component Cp, and a resistive component Rp, as shown in FIG. 2. In other words, elements in the circuit of the gas sensor 21 can be considered as the following arrangement. The resistive component Rs is located on the working electrode 21a side and is connected in series to the capacitive component Cp and the resistive component Rp, which are connected in parallel to each other. The capacitive component Cp and the resistive component Rp, which are connected in parallel to each other, are located on the counter electrode 21b side.

A resistor R3 is connected in parallel to the gas sensor 21. A resistor R4 is connected to the working electrode 21a side of the gas sensor 21. A resistor R5 is connected to the counter electrode 21b side of the gas sensor 21.

The constant voltage circuit 22 generates a reference voltage for the sensor 2. The constant voltage circuit 22 is connected to the counter electrode 21b side of the gas sensor 21, as shown in FIG. 2. The constant voltage circuit 22 includes a resistor R1, a resistor R2, a capacitor C1, a capacitor C2, and an OP amplifier U1. The resistor R1 is connected to a voltage VCC supplied by the power supply 4.

The resistor R2 is connected in series to the resistor R1 and is connected to the ground potential. The capacitor Cl is connected in parallel to the resistor R2 and in series to the resistor R1, and is connected to the ground potential. The OP amplifier U1 has a positive side connected to a point between the resistors R1 and R2, and a negative side connected to the output. The capacitor C2 is connected between the voltage VCC of the OP amplifier U1 and the ground potential.

The signal output 23 is connected to the gas sensor 21 and outputs a detection signal based on power input from the gas sensor 21. The signal output 23 converts a current into a voltage to output the detection signal. The signal output 23 includes a resistor R6, a resistor R7, a resistor R9, a capacitor C3, a capacitor C4, and an OP amplifier U2, as shown in FIG. 2. The resistor R6 is connected to the working electrode 21a side of the gas sensor 21 and to the negative side of the OP amplifier U2. The resistor R7 is connected to the counter electrode 21b side of the gas sensor 21 and is connected to a positive side of the OP amplifier U2. The resistor R9 and the capacitor C3 are connected on the working electrode 21a side of gas sensor 21 in parallel to the resistor R6 and the OP amplifier U2. The capacitor C4 is connected between the voltage VCC of the OP amplifier U2 and the ground potential.

A resistor R8 is connected to a point between the resistor R7 and the positive side of the OP amplifier U2. The resistor R8 is connected to a switch Q1. The switch Q1 is switched between an on state in which a current flows from the resistor R8 side to the ground potential, and an off state in which no current flows from the resistor R8 side to the ground potential in response to an on/off control signal from the controller 1.

The resistor R10 is connected to an output side of the OP amplifier U2. The detection signal is output from the resistor R10 to the controller 1. Specifically, the detection signal is amplified by an amplification circuit and then input to the controller 1. A capacitor C5 is connected between the resistor R10 and the ground potential.

The switch Q1 switches the circuit between a charging state in which electric charge is stored between the working electrode 21a and the counter electrode 21b of the gas sensor 21, and a discharging state in which the electric charge between the working electrode 21a and the counter electrode 21b of the gas sensor 21 is released. Specifically, the switch Q1 is turned on to bring the circuit into the charging state in which the electric charge is stored between the working electrode 21a and the counter electrode 21b of the gas Sensor 21. Also, the switch Q1 is turned off to bring the circuit into the discharging state in which the electric charge between the working electrode 21a and the counter electrode 21b of the gas sensor 21 is released. Also, the switch Q1 is turned off when the gas is detected.

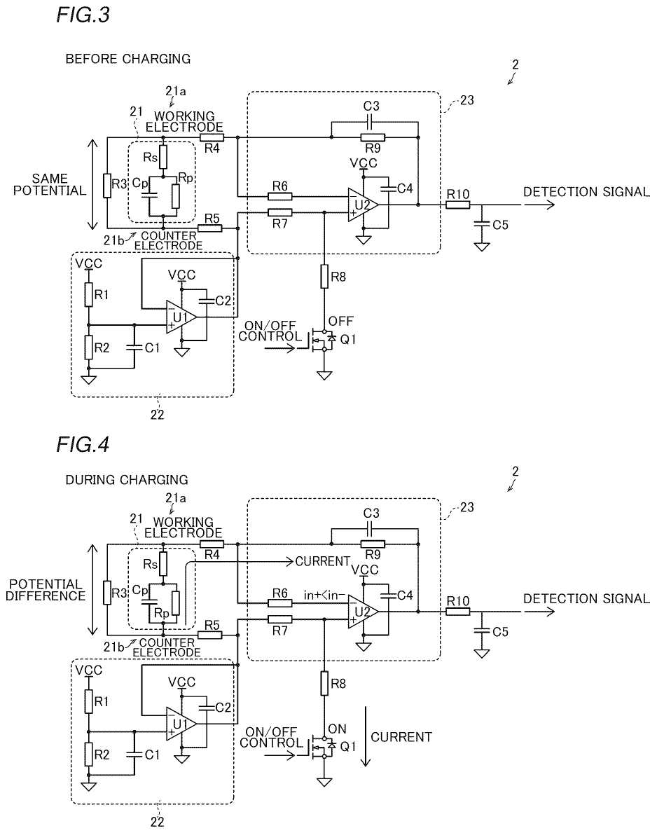

As shown in FIG. 3, in a case in which the switch Q1 is in the off state before charging, no current normally flows in the gas sensor 21 if the to-be-detected gas is not present.

Since no current flows in the gas sensor 21 before charging, the working electrode 21a and the counter electrode 21b are brought to the same potential by negative feedback in the OP amplifier U2. In other words, the capacitive component Cp has no electric charge.

As shown in FIG. 4, when the switch Q1 is turned on to charge the gas sensor, the resistor R8 is connected to the ground potential so that a positive-side voltage of the OP amplifier U2 is reduced (int+<in−). In other words, the voltage on the positive side of the OP amplifier U2 is a voltage obtained by multiplying a reference voltage Vref by the voltage divider ratio provided by the resistors R7 and R8. Accordingly, the input terminal voltages of the OP amplifier U2 become unbalanced so that an output voltage of the OP amplifier U2 decreases.

Consequently, a current flows in a path from the reference voltage Vref through the resistor R5, the capacitive component Cp//resistive component Rp, the resistive component Rs, the resistor R4 and the capacitor C3//resistor R9 to the output side of the OP amplifier U2. As a result, a potential difference is generated in the capacitive component Cp of the gas sensor 21 so that the capacitive component Cp is charged.

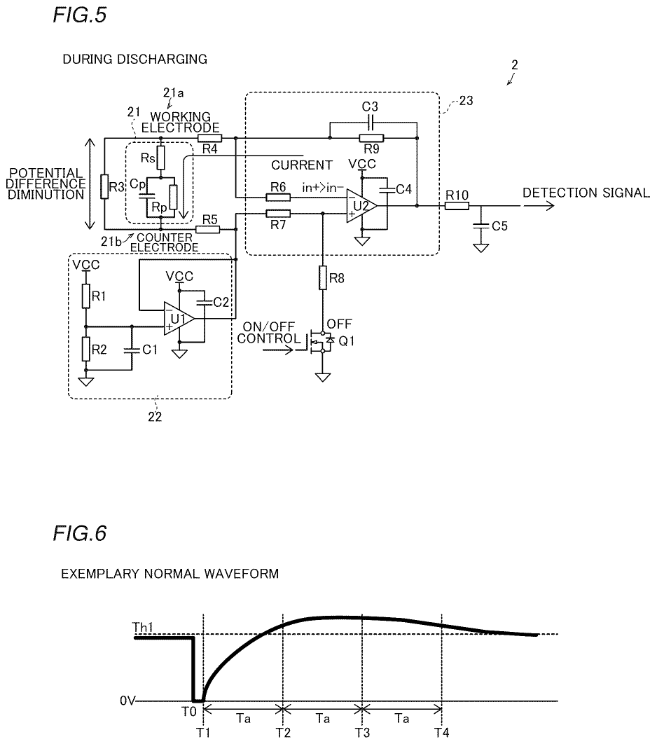

As shown in FIG. 5, when the switch Q1 is turned off to discharge after charging, the resistor R8 becomes opened so that the positive-side voltage of the OP amplifier U2 returns to its initial reference voltage Vref. Accordingly, since the potential on the negative side of the OP amplifier U2 decreases (in+>in−) due to charging, the voltage on the output side of the OP amplifier U2 increases. Consequently, a current flows in the path from the output side of the OP amplifier U2 through the capacitor C3//resistor R9, the resistor R4, the resistive component Rs, the capacitive component Cp//resistive component Rp and the resistor R5 to the reference voltage Vref. As a result, the potential difference in the gas sensor 21 diminishes. As the potential difference in the gas sensor 21 diminishes, the output voltage from the OP amplifier U2 gradually decreases and eventually converges to a state before charging.

As shown in FIG. 6, charging starts at time T0, and the charging is then switched to discharging at time T1. When the charging starts, the detection signal drops to 0 V.

Subsequently, when the charging is switched to discharging, the detection signal rises, exceeds a voltage before the charging, and then converges to the voltage before charging.

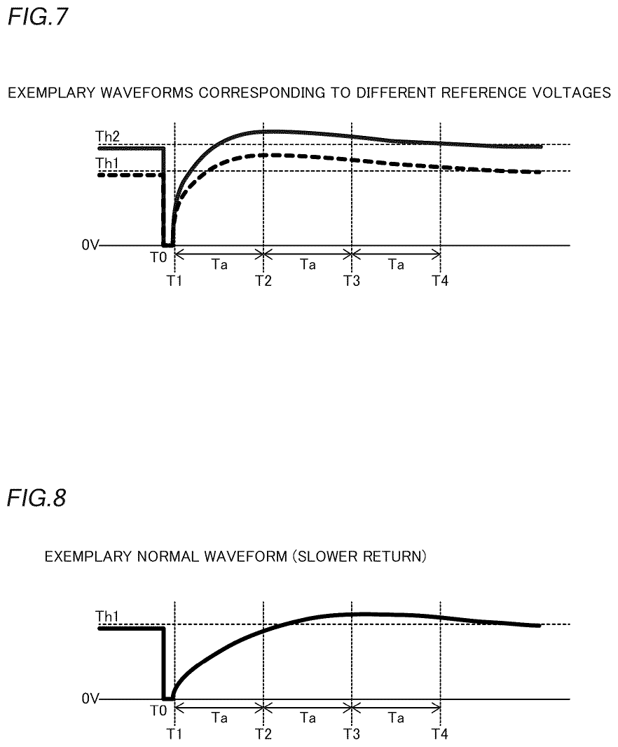

As shown in FIG. 7, the reference voltage of the gas sensor 21 may vary depending on the individual gas sensor. In this case, when discharging after charging, the detection signal exceeds the reference voltage, which is the voltage before charging, and then converges to the reference voltage.

As shown in FIG. 8, the detection signal of the gas sensor 21 may slowly return when discharging after charging depending on the individual gas sensor. In other words, the time required for the voltage of the gas sensor 21 to return when discharging after charging may vary depending on the individual gas sensor.

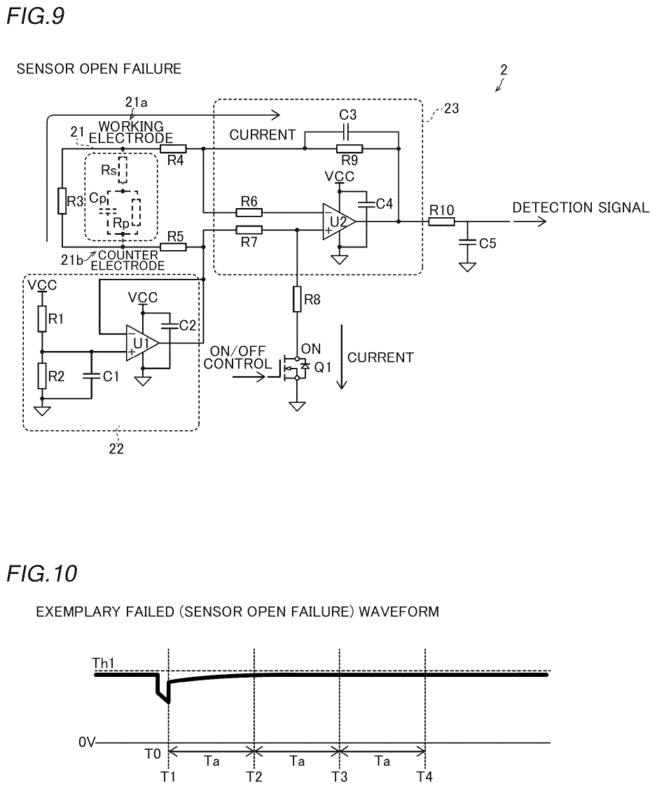

Also, as shown in FIG. 9, if the gas sensor 21 fails due to a sensor open failure, the capacitive component Cp is lost so that the gas sensor 21 is not charged even when the switch Q1 is turned on. In other words, if the gas sensor 21 fails due to the sensor open failure, even when the switch Q1 is turned on to reduce the voltage on the output side of the OP amplifier U2 in order to draw a current, the gas sensor 21 is not charged. Also, since the gas sensor 21 is not charged, the voltage of the detection signal does not sufficiently rise even when the switch Q1 is switched from the on state to the off state.

In other words, if the gas sensor 21 fails due to the sensor open failure, the detection signal does not drop to 0 V even when the switch Q1 is turned on at time T0, as shown in FIG. 10. Also, even when the switch Q1 is turned off at time T1, the detection signal converges to the initial voltage without exceeding the initial voltage.

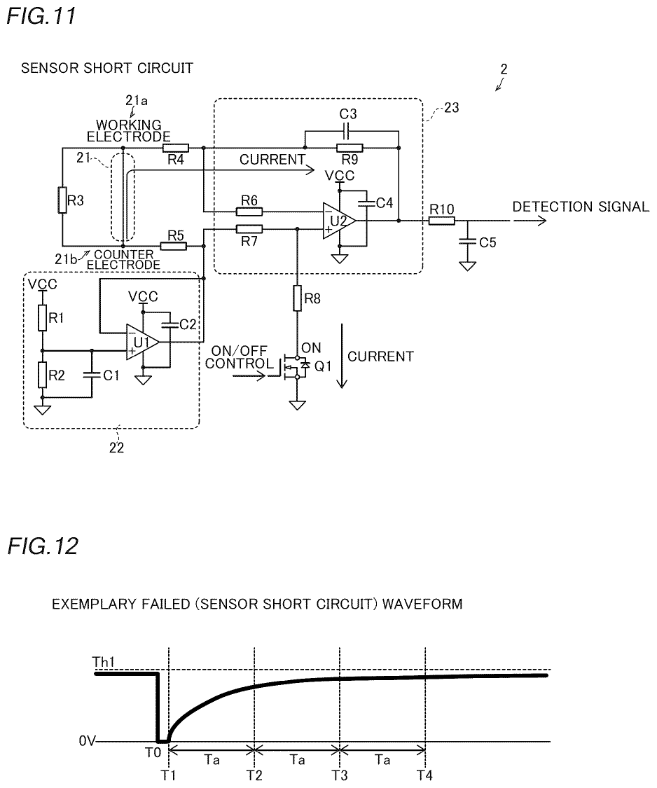

Also, as shown in FIG. 11, if the gas sensor 21 fails due to a sensor short circuit, the capacitive component Cp is lost so that the gas sensor 21 is not charged even when the switch Q1 is turned on. In other words, if the gas sensor 21 fails due to the sensor short circuit, even when the switch Q1 is turned on to reduce the voltage on the output side of the OP amplifier U2 in order to draw a current, the gas sensor 21 is not charged. Also, since the gas sensor 21 is not charged, the voltage of the detection signal does not sufficiently rise even when the switch Q1 is switched from the on state to the off state.

In other words, if the gas sensor 21 fails due to the sensor short circuit, the detection signal drops to 0 V when the switch Q1 is turned on at time T0, as shown in FIG. 12.

Subsequently, although the switch Q1 is turned off at time T1, the detection signal converges to the initial voltage without exceeding the initial voltage.

Here, in this embodiment, the controller 1 determines whether the gas sensor 21 fails based on the outputs of the detection signals acquired after discharging the gas sensor 21 and a predetermined threshold based on the output of the detection signal before charging the gas sensor 21. Specifically, the controller 1 determines that the gas sensor 21 fails if all of the outputs of the detection signals acquired after charging and then discharging the gas sensor 21 are not greater than a predetermined threshold based on the output of the detection signal output before charging the gas sensor 21.

In other words, the controller 1 sets the predetermined threshold based on the detection signal before charging the gas sensor 21. For example, as shown in FIG. 7, the controller 1 sets the predetermined threshold based on the detection signal before charging. In a case in which a value of the detection signal of the gas sensor 21 before charging is relatively small as represented by a dashed waveform in FIG. 7, a predetermined threshold Th1 is set based on the detection signal before charging. Also, in a case in which a value of the detection signal of the gas sensor 21 before charging is relatively large as represented by a solid waveform, a predetermined threshold Th2 (Th2>Th1) is set based on the detection signal before charging.

Also, the controller 1 sets the predetermined threshold to a value larger than the detection signal before charging the gas sensor 21. For example, the controller 1 sets the predetermined threshold to a value that is obtained by adding a constant value to the detection signal before charging.

Alternatively, the controller 1 sets the predetermined threshold to a value that is increased by a predetermined percentage (e.g., 1% to 10%) of the detection signal before charging.

In this embodiment, the controller 1 performs failure diagnosis of the gas sensor 21 based on the detection signals from the signal output 23 when the gas sensor 21 is switched between charging (on state) and discharging (off state) by the switch Q1. Specifically, the controller 1 acquires, at different times, a plurality of detection signals after discharging the gas sensor 21 and determines whether the gas sensor 21 fails based on all of the plurality of detection signals. Specifically, the controller 1 determines that the gas sensor 21 fails if all of the plurality of detection signals acquired are not greater than the predetermined threshold.

For example, as shown in FIG. 6, the controller 1 acquires the detection signals after charging and then discharging at times T2, T3, and T4. In an exemplary case shown in FIG. 6, values of the detection signals exceed the predetermined threshold Th1 between the time T1 and the time T2 after charging and then discharging. In other words, the detection signals exceeds the predetermined threshold Th1 at times T2, T3 and T4. In this case, the controller 1 determines that the gas sensor 21 is in a normal state.

In an exemplary case shown in FIG. 10, after charging (switch Q1 in the on state) and then discharging (switch Q1 in the off state), no detection signal exceeds the predetermined threshold Th1. In other words, the detection signal becomes not greater than the predetermined threshold Th1 at any of the times T2, T3 and T4. In this case, the controller 1 determines that the gas sensor 21 fails.

In exemplary case shown in FIG. 12, after charging (switch Q1 in the on state) and then discharging (switch Q1 in the off state), no detection signal exceeds the predetermined threshold Th1. In other words, the detection signal becomes not greater than the predetermined threshold Th1 at any of the times T2, T3 and T4. In this case, the controller 1 determines that the gas sensor 21 fails.

Also, when the detection signal acquired after charging and then discharging the gas sensor 21 exceeds the predetermined threshold, the controller 1 may determine that the gas sensor 21 is in a normal state and may skip acquisition of the detection signals for failure diagnosis after that. For example, in the exemplary case shown in FIG. 6, the controller 1 acquires the detection signal after charging and then discharging at time T2. Since the detection signal acquired at time T2 exceeds the predetermined threshold Th1, the controller 1 determine that the gas sensor 21 is in a normal state. Also, the controller 1 skips acquisition of the detection signals for failure diagnosis at the subsequent times T3 and T4. Also, in the exemplary case shown in FIG. 8, the controller 1 acquires the detection signal after charging and then discharging at time T2. Since the detection signal acquired at time T2 is not greater than the predetermined threshold Th1, the controller 1 acquires the detection signal after charging and then discharging at time T3. Since the detection signal acquired at time T3 exceeds the predetermined threshold Th1, the controller 1 determine that the gas sensor 21 is in a normal state. Also, the controller 1 skips acquisition of the detection signals for failure diagnosis at the subsequent time T4.

Also, the controller 1 acquires the detection signals at predetermined intervals after charging and then discharging the gas sensor 21, and determines whether the gas sensor 21 is in a normal state or in a failure state based on the plurality of detection signals acquired. Specifically, as shown in FIG. 6, the controller 1 acquires the detection signals at time intervals Ta from start of discharging. For example, the time interval Ta is approximately 0.1 to several seconds. Preferably, the time interval Ta is approximately one second.

Also, the controller 1 acquires the detection signals at predetermined intervals longer than the time period required to charge the gas sensor 21 after charging and then discharging the gas sensor 21, and determines whether the gas sensor 21 is in a normal state or in a failure state based on the plurality of detection signals acquired. For example, the controller 1 acquires the detection signals for determination of failure at predetermined time intervals of several to several ten times the charging time.

Also, the controller 1 acquires the plurality of detection signals at three or more different times after charging and then discharging the gas sensor 21, and determines whether the gas sensor 21 is in a normal state or in a failure state based on three or more detection signals acquired. For example, as shown in FIG. 6, the controller 1 acquires the detection signals for determination of failure at three different times T2, T3, and T4 after discharging.

Also, in this embodiment, the controller 1 acquires, at a first time point, a first difference, which is a difference between the detection signal that exceeds the predetermined threshold after charging and then discharging the gas sensor 21, and the predetermined threshold. Specifically, the controller 1 acquires, at the first time point, the first difference, which is a difference between the detection signal that exceeds the predetermined threshold in the plurality of detection signals acquired at different times after charging and then discharging the gas sensor 21, and the predetermined threshold. Also, the controller 1 acquires, at a second time point after the first time point, a second difference, which is a difference between the detection signal that exceeds the predetermined threshold after charging and then discharging the gas sensor 21 and the predetermined threshold.

Specifically, the controller 1 acquires, at the second time point after the first time point, the second difference, which is a difference between the detection signal that exceeds the predetermined threshold in the plurality of detection signals acquired at different times after charging and then discharging the gas sensor 21, and the predetermined threshold. Subsequently, the controller 1 compares the first difference and the second difference to determine a deterioration state of the gas sensor 21.

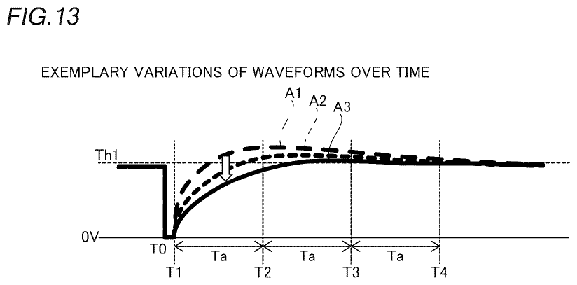

For example, as shown in FIG. 13, in a case in which determination of failure is first conducted at a time point A1, is then conducted at a time point A2, and after that is conducted at time point A3, return of the detection signal after discharging may become slower over time. From this viewpoint, the deterioration state is determined by comparing the differences when the detection signals exceed the predetermined threshold at these time points. Here, the time interval for the time point at which determination of failure is conducted is set to range from one day to several months, for example.

In an exemplary case shown in FIG. 13, since the detection signal at the time point Al exceeds the predetermined threshold Th1 at time T2, the difference at time T2 is acquired. Since the detection signal at the time point A2 exceeds the predetermined threshold Th1 at time T2, the difference at time T2 is acquired. Since the detection signal at the time point A3 exceeds the predetermined threshold Th1 at time T3, the difference at time T3 is acquired.

The controller 1 determines the deterioration state of the gas sensor 21 based on a rate of change or an amount of change of the difference at each time point, for example.

Also, the controller 1 sets the predetermined threshold in accordance with the charging time in failure diagnosis of the gas sensor 21. Specifically, the controller 1 changes the charging time in accordance with the state of the gas sensor 21 in failure diagnosis. If the charging time is long, the controller 1 sets a larger predetermined threshold based on the detection signal before charging, and if the charging time is short, the controller sets a smaller predetermined threshold based on the detection signal before charging.

Also, if the detection signal acquired after charging and then discharging the gas sensor 21 is close to the predetermined threshold, the controller 1 may increase the charging time and perform the failure diagnosis again. For example, if the detection signal after discharging in failure diagnosis is substantially equal to the predetermined threshold and if the detection signal is a value that does not exceed but almost reaches the predetermined threshold, the controller 1 increases the charging time and performs failure diagnosis again.

Also, the controller 1 performs no failure diagnosis of the gas sensor 21 if the detection signal satisfies a predetermined condition. For example, the controller 1 may perform no failure diagnosis of the gas sensor 21 if an alarm level of gas is detected based on the detection signal. In other words, although the gas detection apparatus 100 according to this embodiment can perform failure diagnosis of the gas sensor 21 irrespective of the atmosphere, the gas detection apparatus can perform no failure diagnosis in order to give priority to an alarm from the viewpoint of user protection or to take a load on the gas sensor 21 in consideration, for example. Also, the controller 1 may perform no failure diagnosis of the gas sensor 21 if the output of the detection signal reaches a predetermined value one or more times within a predetermined period. Also, the controller 1 may perform no failure diagnosis if the output of the detection signal is kept not smaller than a a predetermined value for a predetermined period, for example.

Also, the controller 1 detects the gas to be detected based on a cumulative value of the detection signals except during the failure diagnosis. In other words, in order to detect the gas to be detected, in a case in which the detection signals in the failure diagnosis are accumulated, the controller 1 starts detecting the gas with the cumulative value being reset.

### Advantages of the Embodiment

In this embodiment, the following advantages are obtained.

Also, in this embodiment, as described above, the controller 1 is provided which determines whether the gas sensor 21 fails based on the output of the detection signal acquired after discharging the gas sensor 21 and a predetermined threshold based on the output of the detection signal before charging the gas sensor 21. Accordingly, even in a case in which the output voltage of the gas sensor 21 when charged and discharged varies due to presence of a gas to be detected in its atmosphere, it is possible to set the predetermined threshold by using the output of the detection signal before charging the gas sensor 21 as a reference value. Consequently, in a case in which the gas sensor 21 is charged and then discharged, since the output of the detection signal returns to a value before charging, it is possible to set the predetermined threshold for failure diagnosis to an appropriate value in accordance with the atmosphere. As a result, it is possible to accurately perform failure diagnosis of the gas sensor 21 irrespective of the atmosphere.

Also, in this embodiment, as described above, the controller 1 sets the predetermined threshold to a value larger than the output of the detection signal before charging the gas sensor 21. Accordingly, since the output of the detection signal is reliably prevented from exceeding the predetermined threshold in the event of failure by setting the predetermined threshold to a value greater than the detection signal before charging the gas sensor, it is possible to accurately determine whether the gas sensor fails.

Also, in this embodiment, as described above, a plurality of outputs of the detection signals after discharging the gas sensor 21 are acquired at different time points, and it is determined whether the gas sensor 21 fails based on all of the plurality of outputs of the detection signals. Accordingly, even in a case in which the time period until the output voltage of the gas sensor 21 exceeds the threshold when the gas sensor is charged and discharged varies depending on the individual gas sensor 21, since the plurality of outputs of the detection signals are acquired at different times after discharging the gas sensor and determines that the gas sensor fails if all of the plurality of outputs of the detection signals are not greater than the predetermined threshold, it is possible to accurately perform failure diagnosis of the gas sensor 21 irrespective of the atmosphere even in a case individual gas sensors 21 have differences.

Also, in this embodiment, as described above, the controller 1 acquires, at predetermined intervals, the plurality of outputs of the detection signals after discharging the gas sensor 21 and determines whether the gas sensor 21 is in a normal state or in a failure state based on the plurality of outputs of the detection signals acquired.

Accordingly, since the plurality of outputs of the detection signals are acquired at predetermined intervals after discharging the gas sensor, it is possible to reduce increase in processing load as compared with a case in which the outputs of the detection signals are continuously acquired after discharging the gas sensor. Also, even in a case in which the time period until the output of the detection signal of the gas sensor exceeds the threshold after discharging varies depending on the individual gas sensor 21, it is possible to accurately perform failure diagnosis of the gas sensor 21 by acquiring the plurality of outputs of the detection signals at predetermined intervals.

Also, in this embodiment, as described above, the controller 1 acquires the plurality of outputs of the detection signals at predetermined intervals longer than a time period required to charge the gas sensor 21 and determines whether the gas sensor 21 is in a normal state or in a failure state based on the plurality of outputs of the detection signals acquired. Accordingly, since the outputs of the detection signals after discharging the gas sensor are acquired at time intervals sufficiently longer than the time period required to charge the gas sensor, it is possible to further reduce increase in processing load as compared with a case in which a larger number of outputs of the detection signals are acquired at shorter time intervals.

Also, in this embodiment, as described above, the controller 1 acquires the plurality of outputs of the detection signals at three or more different times and determines whether the gas sensor 21 is in a normal state or in a failure state based on three or more outputs of the detection signals acquired. Accordingly, since the plurality of outputs of the detection signals are acquired at three or more different times, it is possible to determine whether the gas sensor fails by acquiring the outputs of the detection signals after charging over a relatively long time period.

Also, in this embodiment, as described above, the controller 1 performs no failure diagnosis of the gas sensor 21 if the output of the detection signal satisfies a predetermined condition. Accordingly, since no failure diagnosis of the gas sensor is performed if the output of the detection signal satisfies a predetermined condition, it is possible to prevent interruption of detection of a gas to be detected due to failure diagnosis.

Also, in this embodiment, as described above, the controller 1 detects the gas to be detected based on a cumulative value of the outputs of the detection signals except during the failure diagnosis. Accordingly, since values of the outputs of the detection signals when the gas sensor is charged and discharged during the failure diagnosis are not added to the cumulative value, it is possible to prevent incorrect detection of the gas to be detected.

### Modified Embodiments

Note that the embodiment disclosed this time must be considered as illustrative in all points and not restrictive. The scope of the present invention is not shown by the above description of the embodiments but by the scope of claims for patent, and all modifications (modified embodiments) within the meaning and scope equivalent to the scope of claims for patent are further included.

For example, while the example in which one gas sensor is provided in the gas detection apparatus has been shown in the aforementioned embodiment, the present invention is not limited to this. In the present invention, a plurality of gas sensors detecting gases to be detected different from each other may be provided in the gas detection apparatus. In this configuration, the controller may apply the diagnosis according to the invention to at least one of the gas sensors.

Also, the gas detection apparatus may have another alarm function. For example, the gas detection apparatus may have a fire alarm (fire warning) function.

Also, while the example in which the detection signals are acquired at a plurality of different times after charging and then discharging in diagnosis of the gas sensor has been shown in the aforementioned embodiment, the present invention is not limited to this. In the present invention, the detection signal may be acquired at a certain one time after charging and then discharging.

Also, while the example in which the detection signals are acquired at three different times after charging and then discharging in diagnosis of the gas sensor has been shown in the aforementioned embodiment, the present invention is not limited to this. In the present invention, the detection signals may be acquired at two different times or four or more different times after charging and then discharging.

Also, while the example in which the detection signals are acquired at predetermined intervals after charging and then discharging in diagnosis of the gas sensor has been shown in the aforementioned embodiment, the present invention is not limited to this. In the present invention, the detection signals may be successively acquired after charging and then discharging in diagnosis of the gas sensor. Also, the detection signals may be acquired at different time intervals after charging and then discharging in diagnosis of the gas sensor.

Also, while the example in which it is determined that the gas sensor fails if the output acquired after discharging the gas sensor is not greater than a predetermined threshold based on the output of the detection signal before charging the gas sensor has been shown in the aforementioned embodiment, the present invention is not limited to this. In the present invention, it may be determined that the gas sensor fails if the output acquired after discharging the gas sensor is not smaller than a predetermined threshold based on the output before charging the gas sensor. For example, in a case in which the output of the gas sensor increases when charging and decreases when discharging, it may be determined that the gas sensor fails if the output of the gas sensor after discharging does not become smaller than the threshold.

Also, a predetermined range may be set in accordance with the predetermined threshold based on the output before charging the gas sensor, and it may be determined that the gas sensor fails if the output of the gas sensor after discharging falls within or outside the predetermined range.

### DESCRIPTION OF REFERENCE NUMERALS

1; controller
21; gas sensor
21a; working electrode
21b; counter electrode
100; gas detection apparatus

1. A gas detection apparatus comprising
a controller performing failure diagnosis of a gas sensor including a working electrode and a counter electrode based on outputs from the gas sensor while switching between a charging state in which electric charge is stored in the gas sensor, and a discharging state in which the electric charge stored in the gas sensor is released, wherein
the controller determines whether the gas sensor fails based on the output(s) acquired after discharging the gas sensor and a predetermined threshold based on the output before charging the gas sensor.

2. The gas detection apparatus according to claim 1, wherein the controller sets the predetermined threshold to a value greater than the output before charging the gas sensor.

3. The gas detection apparatus according to claim 1, wherein the controller acquires, at different times, a plurality of outputs after discharging the gas sensor as the output(s) acquired after discharging the gas sensor and determines whether the gas sensor fails based on all of the plurality of outputs.

4. The gas detection apparatus according to claim 3, wherein the controller acquires, at predetermined intervals, the plurality of outputs after discharging the gas sensor and determines whether the gas sensor is in a normal state or in a failure state based on the plurality of outputs acquired.

5. The gas detection apparatus according to claim 4, wherein the controller acquires the plurality of outputs at the predetermined intervals longer than a time period required to charge the gas sensor and determines whether the gas sensor is in a normal state or in a failure state based on the plurality of outputs acquired.

6. The gas detection apparatus according to claim 3, wherein the controller acquires the plurality of outputs at three or more different times and determines whether the gas sensor is in a normal state or in a failure state based on three or more outputs acquired as the plurality of outputs.

7. The gas detection apparatus according to claim 1, wherein the controller performs no failure diagnosis of the gas sensor if the output(s) satisfies/satisfy a predetermined condition.

8. The gas detection apparatus according to claim 1, wherein the controller detects a gas to be detected based on a cumulative value of the outputs except during the failure diagnosis.

9. A method for performing failure diagnosis of a gas sensor including a working electrode and a counter electrode based on outputs from the gas sensor while switching between a charging state in which electric charge is stored in the gas sensor, and a discharging state in which the electric charge stored in the gas sensor is released, the method comprising
determining whether the gas sensor fails based on the output(s) acquired after discharging the gas sensor and a predetermined threshold based on the output before charging the gas sensor.

10. The method for performing failure diagnosis of the gas sensor according to claim 9, wherein a gas detection apparatus is diagnosed by determining whether the gas sensor fails based on the output(s) acquired after discharging the gas sensor and the predetermined threshold based on the output before charging the gas sensor.

11. A method for performing failure diagnosis of a gas Sensor comprising:
acquiring outputs from the gas sensor, which includes a working electrode and a counter electrode, before storing electric charge in the gas sensor to charge the gas sensor;
determining a threshold based on the output before charging the gas sensor;
acquiring the output(s) after discharging the gas sensor by releasing the electric charge stored in the gas sensor; and
determining whether the gas sensor fails based on the threshold and the output(s) after discharging the gas sensor.
